(19) United States
(12) Patent Application Publication
(10) Pub. No.: US 2007/0213970 A1
(43) Pub. Date: Sep. 13, 2007

(54) Application communication session method and apparatus

(75) Inventors: Devarajan Puthupparambil, Mt. Prospect, IL (US); J. Schneider, Grayslake, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc., Alameda, CA (US)

(21) Appl. No.: 11/372,287

(22) Filed: Mar. 9, 2006

(51) Int. Cl. G06F 9/455

(52) U.S. Cl. 703/27

(57) ABSTRACT

Generally speaking, pursuant to these various embodiments, a network element (such as, but not limited to, a gateway) can use (101) a first communication resource to support an application communication session with a first communication platform. By one approach this application communication session is not native to the first communication resource. The network element then uses (102) a second communication resource to at least attempt to extend the application communication session to a second communication platform. By these teachings, when this attempt fails, the network element nevertheless automatically provides (104) a second communication platform application communication session-compatible message to the first communication platform as though the attempt to extend the application communication session to the second communication platform had succeeded.

### TECHNICAL FIELD

This invention relates generally to communications between multiple platforms and more particularly to relatively brief message exchanges.

### BACKGROUND

Communications between communication platforms of various kinds are known in the art. This includes both wireless and wired communications. For example, a Point of Sale (POS) terminal may communicate with a host server using a shared application communication session protocol such as one of the relatively ubiquitous VISA standards. In such a case the application communication session can serve to support, for example, a provision of credit card information to the host server and a corresponding authorization reply to the POS terminal.

In many cases such a communication is facilitated via an intermediary network entity such as a gateway. This may be useful or even necessary because the communication endpoints do not share compatible communication resources. For example, and to continue with the example presented above, a POS terminal may only have dial-up capability that offers access to a TC1000 system. The host server, on the other hand, may comprise an Internet Protocol-based platform. Accordingly, the gateway serves to provide an interface that allows compatible interaction between networks that otherwise employ non-compatible protocols.

In a typical gateway-arbitrated interaction, a first communication platform expresses an indication to the gateway, via a first communication resource, to engage in an application communication session (with, for example, a second communication platform). The gateway then employs a second communication resource (which may very well not be compatible with the first communication resource) to extend that application communication session to the second communication platform.

Such arrangements work well for many purposes. There are at least some application settings, however, where present practices in this regard leave much to be desired. For example, when the above-mentioned attempt to extend the application communication session using a second communication resource fails (because, for example, the target communication platform is unavailable or even presently non-functional) the gateway will ordinarily return a corresponding indication of failure to the originating communication resource. In the above example, this will typically result in disconnecting the dial-in call that the originating communication resource initiated. The latter must therefore either re-dial the original dial-in number (to retry the original target communication platform) or a substitute alternative dial-in number (to try, for example, a different target communication platform).

Such a series of events can become particularly troublesome in application settings that typically involve only relatively short message exchanges. For example, a typical VISA exchange between a POS terminal and a host server may comprise about 7 seconds. The time required to establish a typical call connection adds about an additional 5 seconds. Terminating such a call and re-dialing one or more times can therefore been seen to increase the total transaction time by a considerable percentage.

One simple solution, of course, would be to replace existing dial-in POS terminals with platforms that could communicate more directly with existing host servers. The installed population base of existing POS terminals, however, is sufficiently large so as to render this particular approach unfeasible for any number of attendant reasons.

### BRIEF DESCRIPTION OF THE DRAWINGS

The above needs are at least partially met through provision of the application communication session method and apparatus described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a call flow diagram as configured in accordance with various embodiments of the invention; and

FIG. 4 comprises a call flow diagram configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a network element (such as, but not limited to, a gateway) can use a first communication resource to support an application communication session with a first communication platform. By one approach this application communication session is not native to the first communication resource. The network element then uses a second communication resource to at least attempt to extend the application communication session to a second communication platform. By these teachings, when this attempt fails, the network element nevertheless automatically provides a second communication platform application communication session-compatible message to the first communication platform as though the attempt to extend the application communication session to the second communication platform had succeeded.

If desired, the network element can then automatically attempt to use a communication resource to again at least attempt to extend the application communication session to another communication platform. So configured, the originating communication platform receives an indication that makes it appear as though the desired call and application communication session is successfully underway when, in fact, the first attempt has failed and the network element is transparently attempting additional steps to establish such a session.

This approach, in turn, can lead to ultimate establishment of the desired interconnectivity between the originating communication platform and a suitable target communication platform without necessarily requiring termination of the original first communication resource-based call and re-establishment of a new first communication resource call. This, in turn, can result in a considerable savings of time as compared to prior art practice in this regard.

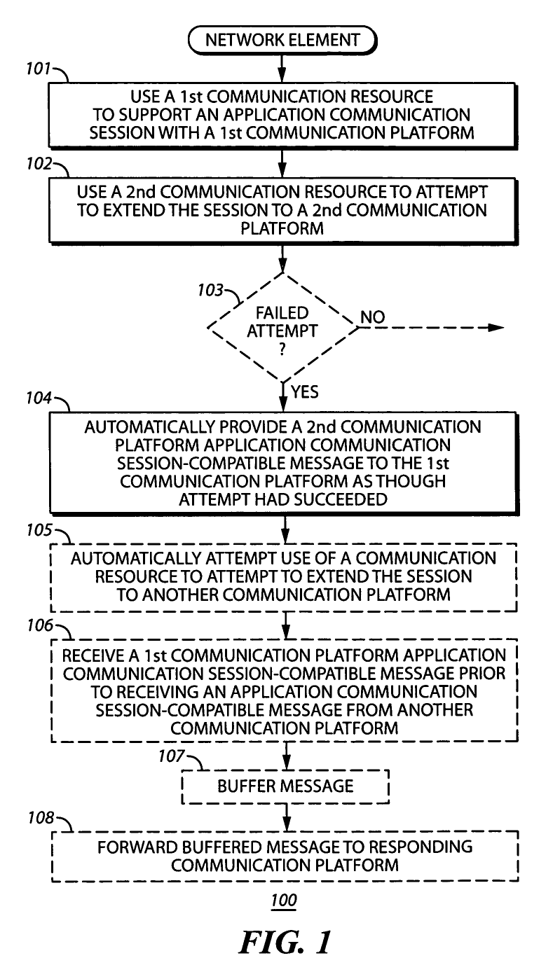

These and other benefits may become clearer upon making a thorough review and study of the following detailed description. Referring now to the drawings, and in particular to FIG. 1, a description of an illustrative process 100 that can be carried out by a corresponding network element (such as, but not necessarily limited to, a gateway) will first be provided.

By this process 100, the network element of choice uses 101 a first communication resource to support an application communication session with a first communication platform. The first communication resource can comprise, for example, a particular physical layer and/or higher layers of a corresponding transport protocol (for example, the upper layers as are defined by the Open Systems Interconnection (OSI) reference model including, but not limited to, the physical layer, the data link layer, the network layer, the transport layer, and so forth though typically not include layer seven (i.e., the application layer)).

The application communication session relates to a particular application to be supported by the first communication resource and might comprise, for example, a VISA protocol application communication session as is known in the art. By one approach, this application communication session is not native to the first communication resource; that is, the former is a separate construct from the latter. As one relatively straightforward example, the application communication session may reside at the layer seven application layer of the OSI reference model.

The first communication platform may comprise, as one useful illustrative example, a Point-of-Sale terminal that seeks to conduct a VISA protocol session with a host server. Such a session might serve, for example, to permit presentation by the Point-of-Sale terminal of a given credit transaction and subsequent authorization of that transaction by the host server. By one approach, this step 101 can comprise, if desired, the network element receiving a communication session request (such as but not limited to a VISA protocol-compatible application communication session request) from the first communication platform and the subsequent responsive establishment of a corresponding communication session using the first communication resource.

This process 100 then provides for the network element using 102 a second communication resource to at least attempt to extend the application communication session to a second communication platform. In a typical scenario this second communication resource will likely be different than the first communication resource and may typically comprise, for example, a Wide Area Network protocol (such as, but not limited to, Internet Protocol or X.25 as are known in the art). This step 102 will ordinarily serve as an effort to contact a target communication platform, such as a host server, via the second communication resource.

This process 100 then optionally determines 103 whether the aforementioned attempt has been successful (for example, within some predefined period of time). When successful, this process 100 can then simply proceed in accordance with existing prior art practice in this regard. Upon detecting, however, that the attempt to extend the application communication session to the second communication platform has failed, this process 100 will accommodate taking one or more responsive actions that differ significantly from prior art practice in this regard.

Those skilled in the art will understand that there are different ways by which such a failed attempt might be recognized or detected. By one approach, such a failure might be detected upon noting a second communication resource connection failure. By another approach, such a failure might be detected upon noting an application communication session connection failure.

In such a case, and regardless of how detected, this process 100 can then automatically provide 104 a second communication platform application communication session-compatible message to the first communication platform as though the attempt to extend the application communication session to the second communication platform had succeeded. For example, when the application communication session comprises a VISA protocol communication session, the second communication platform (i.e., the target host server) would have responded at this point with an ENQ message. Therefore, pursuant to these present teachings, the network element can provide an ENQ message to the first communication platform notwithstanding that the application communication session has not, in fact, been yet successfully extended nor has the second communication platform yet been successfully engaged.

If desired, this process 100 then optionally provides for automatically attempting 105 to use a communication resource (such as the second communication resource or another communication resource as may be available) to at least attempt to extend the application communication session to another communication platform (such as an alternative host server that may also be authorized and able to usefully engage the first communication platform). Those skilled in the art will understand and appreciate that such an action may be taken transparently with respect to the first communication platform; that is, such an action can be taken without providing corresponding notice to the first communication platform. In fact, as the first communication platform has already received the above-mentioned second communication platform application communication session-compatible message, the first communication platform is instead likely acting as though the desired contact is already being successfully prosecuted.

Because the first communication platform is likely acting in such a manner, it is possible that the first communication platform will now source subsequent transmissions as correspond to the application communication session. Accordingly, if desired, this process 100 can also optionally provide for receiving 106 a first communication platform application communication session-compatible message (in response, for example, to the aforementioned second communication platform application communication session-compatible message) prior to the network element having received an application communication session-compatible message from the new target communication platform. By this optional approach this process 100 can then automatically buffer 107 that first communication platform application communication session-compatible message to provide a corresponding buffered message.

Then, when the network element later receives the appropriate application communication session-compatible message from the secondary communication platform, the network element can then automatically forward 108 the buffered message to the secondary communication platform.

So configured, a network element such as a gateway can successfully aid in effecting a useful link between two communication platforms in a manner that avoids the initiating platform from becoming disconnected and necessarily reinitiating the communication process when a first attempt to communicate with a target communication platform fails. This, in turn, can result in significant time savings with respect to the initiating platform. Such savings and efficiencies are particularly noteworthy when the initiating platform utilizes a dial-up communication capability (as is the case, for example, with Point-of-Sale terminals as are presently known in the art).

Those skilled in the art will further understand and appreciate that such a process requires little or no reprogramming for either or both communication end points. This is particularly important when considering the large presently deployed base of Point-of-Sale terminals.

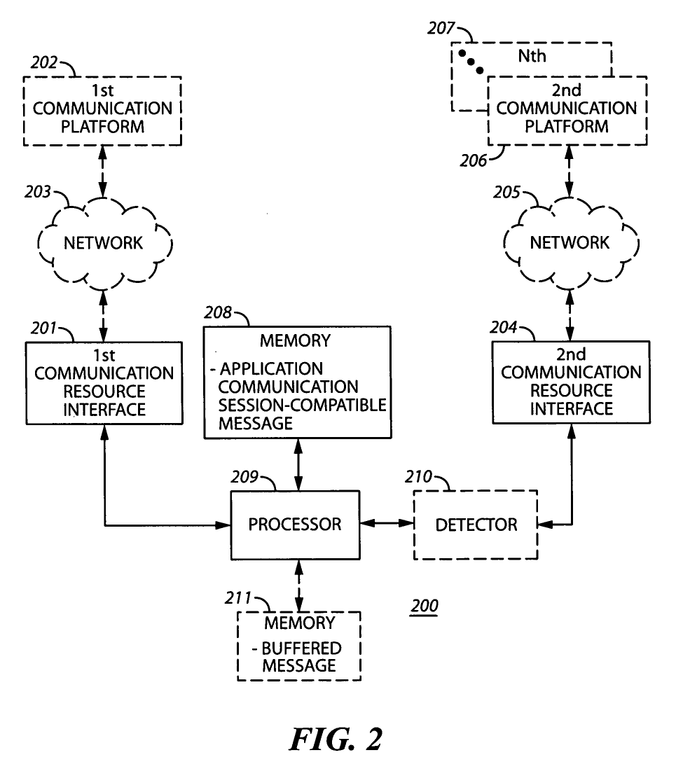

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative embodiment, where the enabling platform comprises a gateway 200, the gateway 200 comprises a first communication resource interface 201. This first communication resource interface 201 couples compatibly to a first communication platform 202 (such as but not limited to a Point-of-Sale terminal) via, for example, an intervening network 203. In somewhat similar fashion this gateway 200 further comprises a second communication resource interface 204 that provides compatible interaction with a second communication platform 206 (or platforms 207) (such as but not limited to a host server) via an intervening network 205 of opportunity.

In this illustrative embodiment, a memory 208 serves to store an application communication session-compatible message (or messages). This message comprises the message that the gateway 200 can provide to the first communication platform 202 when the attempt to extend a present application communication session to the second communication platform 206 fails as described above. For example, when the application communication session comprises a VISA protocol-compatible application communication session, the stored message can comprise, for example, an ENQ message.

This illustrative embodiment then further comprises a processor 209 that operably couples to the aforementioned first communication resource interface 201, the second communication resource interface 204, and the memory 208. In this embodiment the processor 209 is arranged and configured to effect some or all of the teachings and steps as were described above. In particular, for example, the processor 209 can be programmed to respond to a first communication resource-based request from the first communication platform 202 to facilitate an application communication session with the second communication platform 206, wherein the application communication session is not native to the first communication resource, and to then automatically attempt to use a second communication resource to facilitate the application communication session with the second communication platform 206. By one approach, this processor 209 is then further programmed to automatically provide the stored application communication session-compatible message to the first communication platform 202 when the attempt has failed nevertheless make it appear to the first communication platform 202 as though the attempt had been successful.

To aid in facilitating such actions and response, if desired, this embodiment can further comprise a detector 210 that operably couples to both the second communication resource interface 204 and the processor 209. This detector 210 may be configured and arranged, for example, to detect when the aforementioned attempt has failed. Such a detector 210 may comprise, for example, a second communication resource failure detector and/or an application communication session failure detector.

As described above, if desired, this network element can be provided with an ability to receive and store an application communication session message from the first communication platform 202 subsequent to when the network element provides the stored application communication session message stored in the memory 208 but before a connection to another communication platform has in fact been established. To support such functionality, if desired, this embodiment can further comprise a memory 211 that serves to store such a message.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform and/or could be distributed over a plurality of discrete network elements such that the “network element” comprises a virtual network element. It will also be understood that such a shared platform may comprise a wholly or at least partially programmable platform as are known in the art.

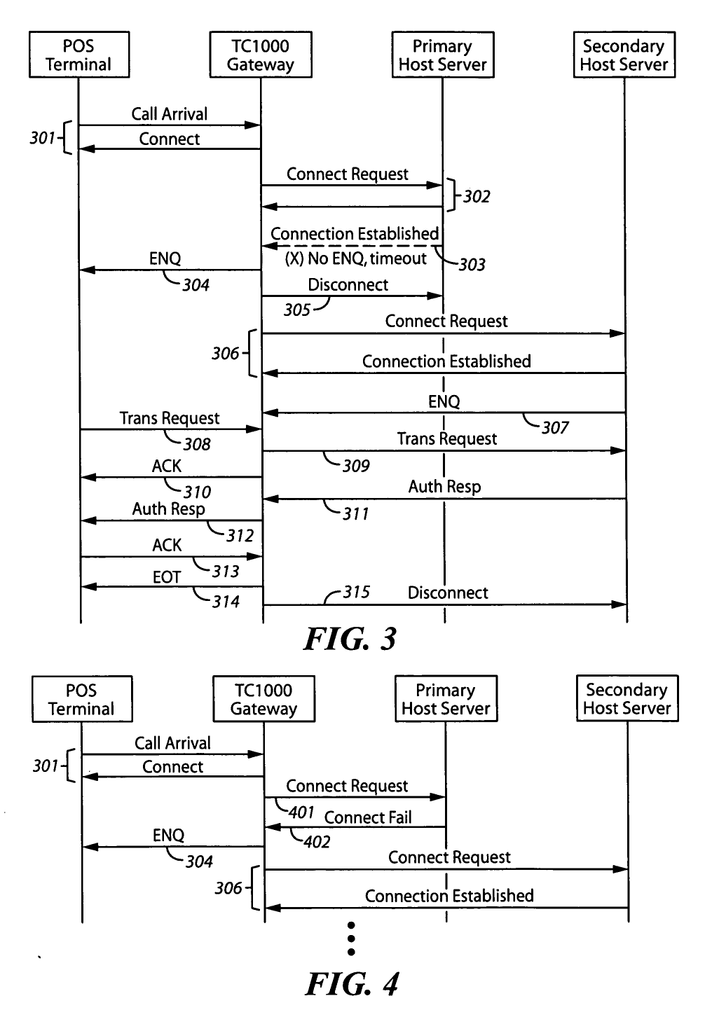

Referring now to FIG. 3, an illustrative example will be provided where these teachings are applied with respect to an application setting that includes a Point-of-Sale terminal, a TC1000 gateway, a primary host server, and a secondary host server. In this illustrative example the Point-of-Sale terminal establishes a call 301 with the TC1000 gateway using a first communication resource to seek to establish a VISA protocol application communication session with the primary host server. The TC1000 gateway then establishes a connection 302 with a primary host server using a second communication resource.

In this example, however, this second communication resource-based connection fails to result in a successful extension of the application communication session. This may be evidenced, for example, by a failure to receive an ENQ message 303 from the primary host server within some predetermined period of time.

As per these teachings, in response to having determined that the attempt to extend the application communication session to the primary host server has failed, the TC1000 gateway transmits an ENQ message 304 to the POS terminal. This, of course, effectively constitutes a representation to the POS terminal that the application communication session has, in fact, been successfully established as the POS terminal is programmed to accept such an ENQ message as having originated with the host server.

The TC1000 gateway also transmits a disconnect message 305 to the primary host server to conclude the second communication resource-based connection. The TC1000 gateway then automatically establishes another communication resource-based connection 306 with a secondary host server to again seek to extend the VISA protocol application communication session on behalf of the POS terminal. In this example, this second attempt succeeds and the secondary host server responds with a VISA protocol application communication session-appropriate response; in this case, an ENQ message 307.

The POS terminal, of course, has already received an ENQ message. Accordingly, if desired, these teachings can further provide for having the gateway simply discard an ENQ message that is received from a host server subsequent to the gateway having already provided such a message to the originating communication platform.

In this example, the POS terminal responds to the earlier received ENQ message 304 by transmitting a transaction request 308 as corresponds to the VISA protocol to the TC1000 gateway. The latter forwards a corresponding transaction request 309 to the secondary host server and also transmits an acknowledgment message 310 to the POS terminal.

In this example this transaction request 308 and 309 can comprise a VISA protocol-compatible message that seeks authorization to accept a particular kind of financial transaction for a given party. In this example, the transaction is authorized and the secondary host server transmits an authorization response message 311 to the TC1000 gateway which then forwards that message 312 to the POS terminal. The latter then transmits an acknowledgement message 313 to the TC1000 gateway, which may or may not be forwarded to the host server, following which the TC1000 gateway transmits an appropriate end of transmission message 314 and disconnect message 315 to conclude the session.

In the illustrative example provided above, the attempt to extend the application communication session to the primary host server failed at the application level notwithstanding that the underlying second communication resource connection was successful. These teachings are also applicable for use in scenarios where the second communication resource itself fails. To illustrate, and referring now to FIG. 4, the TC1000 gateway can again transmit a second communication resource connect request 401 to the primary host server in response to having established the first communication resource connection 301 with the POS terminal. In this example, however, the second communication resource connection itself fails 402.

When such an event occurs, these teachings are still readily applied as is otherwise described above. For example, the TC1000 gateway, in response to detecting this failure of the second communication resource connection, can again nevertheless transmit an ENQ message 304 to the POS terminal to again effectively represent to the latter that the overall effort to extend the application communication session has been successful while also taking steps to establish a connection 306 with a secondary host server and so forth.

There are various ways by which such a network element can select a particular secondary target recipient of the first communication platform's application communication session. By one approach, for example, the network element has access to information regarding alternative platforms that may be used under such circumstances. Such information may be locally available to the network element as when the latter includes such information in a resident memory and/or can be remotely available to the network element via one or more of its network resources. By another approach, the first communication platform itself might embed alternative target preferences or information in its call establishment messages. Other mechanisms will occur to those skilled in the art and may readily be employed in conjunction with these teachings as well.

So configured, considerable time can be saved for communication platforms operating under conditions such as those that typically exemplify Point-of-Sale terminals. This, in turn, can aid in reducing loading requirements on at least some communication resources while also speeding up corresponding transactions as are being supported by the communication platforms themselves. These improvements are readily obtained without requiring any necessary reconfiguration or reprogramming of either end of the communication transaction.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at a network element:
using a first communication resource to support an application communication session, which application communication session is not native to the first communication resource, with a first communication platform;
using a second communication resource to at least attempt to extend the application communication session to a second communication platform;
when the attempt to extend the application communication session to the second communication platform fails, automatically providing a second communication platform application communication session-compatible message to the first communication platform as though the attempt to extend the application communication session to the second communication platform had succeeded.

2. The method of claim 1 wherein the network element comprises a gateway.

3. The method of claim 1 wherein the first communication platform comprises a point-of-sale terminal and the second communication platform comprises a host server.

4. The method of claim 1 wherein using a first communication resource to support an application communication session with a first communication platform comprises:
receiving a communication session request from the first communication platform;
establishing a corresponding communication session using the first communication resource.

5. The method of claim 1 wherein the application communication session comprises a VISA protocol-compatible application communication session.

6. The method of claim 5 wherein automatically providing a second communication platform application communication session-compatible message to the first communication platform comprises providing an ENQ message.

7. The method of claim 1 further comprising:
detecting when the attempt to extend the application communication session to the second communication platform fails.

8. The method of claim 7 wherein detecting when the attempt to extend the application communication session to the second communication platform fails comprises detecting at least one of:
a second communication resource connection failure;
an application communication session connection failure.

9. The method of claim 1 further comprising, subsequent to automatically providing a second communication platform application communication session-compatible message to the first communication platform:
automatically attempting using a communication resource to at least attempt to extend the application communication session to another communication platform.

10. The method of claim 9 wherein the another communication platform comprises a communication platform other than the second communication platform.

11. The method of claim 9 further comprising:
receiving a first communication platform application communication session-compatible message in response to the second communication platform application communication session-compatible message prior to having received an application communication session-compatible message from the another communication platform;
automatically buffering the first communication platform application communication session-compatible message to provide a buffered message.

12. The method of claim 11 further comprising:
upon receiving the application communication session-compatible message from the another communication platform, automatically forwarding the buffered message to the another communication platform.

13. An apparatus comprising:
a first communication resource interface;
a second communication resource interface;
a memory having stored therein an application communication session-compatible message;
a processor that is operably coupled to the first communication resource interface, the second communication resource interface, and the memory and being arranged and configured to:
respond to a first communication resource-based request from a first communication platform to facilitate an application communication session with a second communication platform, wherein the application communication session is not native to the first communication resource;
automatically attempt to use a second communication resource to facilitate the application communication session with the second communication platform;
upon detecting a failure of the attempt, automatically providing the application communication session-compatible message to the first communication platform to make it appear to the first communication platform as though the attempt had been successful.

14. The apparatus of claim 13 wherein the apparatus comprises a gateway.

15. The apparatus of claim 13 wherein the first communication platform comprises a point-of-sale terminal and the second communication platform comprises a host server.

16. The apparatus of claim 13 wherein the application communication session comprises a VISA protocol-compatible application communication session.

17. The apparatus of claim 16 wherein automatically providing the application communication session-compatible message to the first communication platform to make it appear to the first communication platform as though the attempt had been successful comprises providing an ENQ message.

18. The apparatus of claim 13 further comprising:
a detector operably coupled to the second communication resource interface and the processor and being configured and arranged to detect when the attempt has failed.

19. The apparatus of claim 18 wherein the detector comprises at least one of:
a second communication resource failure detector; and
an application communication session failure detector.

20. The apparatus of claim 19 wherein the detector comprises both:
a second communication resource failure detector; and
an application communication session failure detector.

21. The apparatus of claim 13 further comprising:
a second memory operably coupled to the first communication resource interface and the processor and having stored therein a first communication platform application communication session-compatible message as was received in response to the application communication session-compatible message prior to the apparatus having received an application communication session-compatible message from another communication platform.

22. The apparatus of claim 21 wherein the processor is further configured and arranged to automatically forward the first communication platform application communication session-compatible message to the another communication platform upon receiving an application communication session-compatible message from the another communication platform.

23. A network element comprising:
means for using a first communication resource to support an application communication session, which application communication session is not native to the first communication resource, with a first communication platform;
means for using a second communication resource to at least attempt to extend the application communication session to a second communication platform;
means for automatically providing a second communication platform application communication session-compatible message to the first communication platform as though the attempt to extend the application communication session to the second communication platform had succeeded when the attempt to extend the application communication session to the second communication platform fails.

24. The network element of claim 23 wherein the network element comprises a gateway.

25. The network element of claim 23 wherein the first communication platform comprises a point-of-sale terminal and the second communication platform comprises a host server.

26. The network element of claim 23 wherein the means for using a first communication resource to support an application communication session with a first communication platform comprises:
means for receiving a communication session request from the first communication platform;
means for establishing a corresponding communication session using the first communication resource.

27. The network element of claim 23 wherein the application communication session comprises a VISA protocol-compatible application communication session.

28. The network element of claim 27 wherein the means for automatically providing a second communication platform application communication session-compatible message to the first communication platform comprises means for providing an ENQ message.

29. The network element of claim 23 further comprising:
means for detecting when the attempt to extend the application communication session to the second communication platform fails.

30. The network element of claim 29 wherein the means for detecting when the attempt to extend the application communication session to the second communication platform fails comprises means for detecting at least one of:
a second communication resource connection failure;
an application communication session connection failure.

31. The network element of claim 23 further comprising:
means for automatically attempting to use a communication resource to at least attempt to extend the application communication session to another communication platform subsequent to automatically providing a second communication platform application communication session-compatible message to the first communication platform.

32. The network element of claim 31 wherein the another communication platform comprises a communication platform other than the second communication platform.

33. The network element of claim 31 further comprising:
means for receiving a first communication platform application communication session-compatible message in response to the second communication platform application communication session-compatible message prior to having received an application communication session-compatible message from the another communication platform;
means for automatically buffering the first communication platform application communication session-compatible message to provide a buffered message.

34. The network element of claim 33 further comprising:
means for automatically forwarding the buffered message to the another communication platform upon receiving the application communication session-compatible message from the another communication platform.
